(19) United States
(12) Patent Application Publication
(10) Pub. No.: US 2023/0367701 A1
(43) Pub. Date: Nov. 16, 2023

(54) CODE TESTING METHOD AND APPARATUS

(71) Applicant: Alipay (Hangzhou) Information Technology Co., Ltd., Hangzhou (CN)

(72) Inventors: Jianfei ZHANG, Hangzhou (CN); Hailian ZHOU, Hangzhou (CN); Zhiquan ZHOU, Hangzhou (CN); Hongbing ZHAO, Hangzhou (CN)

(21) Appl. No.: 18/314,674

(22) Filed: May 9, 2023

(30) Foreign Application Priority Data
May 10, 2022 (CN) 202210508848.X

(51) Int. Cl. G06F 11/36

(52) U.S. Cl. CPC G06F 11/3684

(57) ABSTRACT

The present specification discloses a code testing method and apparatus. The code testing method includes: determining, for each object under test, all member variables corresponding to the object under test and a variable calling statement corresponding to each member variable, and constructing an operation calling statement sequence based on a calling order corresponding to operations under test included in the object under test; constructing an initial test case corresponding to the object under test based on the variable calling statements and the operation calling statement sequence, each initial test case corresponding to only one object under test; and determining a target test case based on each initial test case, and testing to-be-tested code by using the target test case.

### TECHNICAL FIELD

The present specification relates to the field of software testing, and in particular, to a code testing method and apparatus.

### BACKGROUND

In the process of software development, work of testing software code usually plays an indispensable role, and a test effect often depends on whether writing of test cases is reasonable. With the development of automatic testing technologies, a testing process gradually changes from manual test to automatic test performed by using automatically generated test cases, to reduce labor costs and ensure the smooth development of software.

However, in currently used methods for generating test cases, one generated test case usually includes multiple objects under test, and each operation under test included in the object under test is called in a random order. Execution exceptions easily occur in a process of executing test cases constructed in such a method, and a test effect is poor.

### SUMMARY

The present specification provides a code testing method and apparatus, which, among others, simplify a statement of a test case, reduce the number of test cases, and improve a test effect.

The present specification include, among others, the following technical solutions:

The present specification provides a code testing method, including: determining, for each object under test, all member variables corresponding to the object under test and a variable calling statement corresponding to each member variable, and constructing an operation calling statement sequence based on a calling order corresponding to operations under test included in the object under test; constructing an initial test case corresponding to the object under test based on the variable calling statements and the operation calling statement sequence, each initial test case corresponding to only one object under test; and determining a target test case based on each initial test case, and testing to-be-tested code by using the target test case.

In some implementations, the determining, for each object under test, all the member variables corresponding to the object under test and the variable calling statements corresponding to the member variables specifically includes: for each object under test, determining all the member variables corresponding to the object under test and a variable injection statement corresponding to each member variable; determining a variable initialization statement corresponding to each member variable based on an initial value and a value range corresponding to the member variable; and combining the variable initialization statement and the variable injection statement to construct the variable calling statement corresponding to each member variable.

In some implementations, the determining the target test case based on each initial test case includes: reconstructing a test case based on each initial test case to obtain a candidate test case; and determining the target test case based on each candidate test case.

In some implementations, the reconstructing the test case based on each initial test case to obtain the candidate test case includes: processing an operation parameter corresponding to an operation called in each initial test case and a member variable parameter corresponding to a called member variable to obtain a processed operation parameter and a processed member variable parameter; and reconstructing the test case based on the processed operation parameter, the processed member variable parameter, and an operation calling statement and a variable calling statement that are included in each initial test case, to obtain the candidate test case.

In some implementations, the reconstructing the test case based on each initial test case to obtain the candidate test case includes: for each initial test case, if an object under test corresponding to the initial test case does not include a determined to-be-inserted operation under test, reconstructing the test case based on an operation calling statement corresponding to the to-be-inserted operation under test and based on an operation calling statement and a variable calling statement that are included in the initial test case, to obtain the candidate test case.

In some implementations, the determining the target test case based on each candidate test case includes: determining, for each candidate test case, another operation calling statement different from an operation calling statement included in the initial test case from the candidate test case as a target calling statement; and deleting, based on a predetermined (or dynamically determined) probability, at least part of target calling statements included in the candidate test case, to determine the target test cases based on the candidate test case from which the at least part of target calling statements are deleted.

In some implementations, the determining the target test case based on each candidate test case includes: for each candidate test case, if a comprehensive coverage rate corresponding to the candidate test case is greater than a predetermined (or dynamically determined) threshold, and a coverage target determined after code testing is performed by using the candidate test case is not completely same as a coverage target determined after code testing is performed by using the determined target test case, using the candidate test case as the target test case.

In some implementations, the method further includes: traversing each line of code in the target test case to identify exception code included in the target test case; and if it is determined that a variation of a comprehensive coverage rate obtained after code testing is performed based on another code different from the exception code in the target test case is less than a predetermined (or dynamically determined) variation, deleting the exception code.

The present specification provides a code testing apparatus, including: a determining module, configured to: determine, for each object under test, all member variables corresponding to the object under test and a variable calling statement corresponding to each member variable, and construct an operation calling statement sequence based on a calling order corresponding to operations under test included in the object under test; a construction module, configured to construct an initial test case corresponding to the object under test based on the variable calling statements and the operation calling statement sequence, each initial test case corresponding to only one object under test; and a testing module, configured to: determine a target test case based on each initial test case, and test to-be-tested code by using the target test case.

In some implementations, the determining module is configured to: for each object under test, determine all the member variables corresponding to the object under test and a variable injection statement corresponding to each member variable; determine a variable initialization statement corresponding to each member variable based on an initial value and a value range corresponding to the member variable; and combine the variable initialization statement and the variable injection statement to construct the variable calling statement corresponding to each member variable.

In some implementations, the testing module is configured to: reconstruct a test case based on each initial test case to obtain a candidate test case; and determine the target test case based on each candidate test case.

In some implementations, the testing module is configured to: process an operation parameter corresponding to an operation called in each initial test case and a member variable parameter corresponding to a called member variable to obtain a processed operation parameter and a processed member variable parameter; and reconstruct the test case based on the processed operation parameter, the processed member variable parameter, and an operation calling statement and a variable calling statement that are included in each initial test case, to obtain the candidate test case.

In some implementations, the testing module is configured to: for each initial test case, if an object under test corresponding to the initial test case does not include a determined to-be-inserted operation under test, reconstruct the test case based on an operation calling statement corresponding to the to-be-inserted operation under test and based on an operation calling statement and a variable calling statement that are included in the initial test case, to obtain the candidate test case.

In some implementations, the testing module is configured to: determine, for each candidate test case, another operation calling statement different from an operation calling statement included in the initial test case from the candidate test case as a target calling statement; and delete, based on a predetermined (or dynamically determined) probability, at least part of target calling statements included in the candidate test case, to determine the target test cases based on the candidate test case from which the at least part of target calling statements are deleted.

In some implementations, the testing module is configured to: for each candidate test case, if a comprehensive coverage rate corresponding to the candidate test case is greater than a predetermined (or dynamically determined) threshold, and a coverage target determined after code testing is performed by using the candidate test case is not completely same as a coverage target determined after code testing is performed by using the determined target test case, use the candidate test case as the target test case.

In some implementations, the testing module is further configured to: traverse each line of code in the target test case to identify exception code included in the target test case; and if it is determined that a variation of a comprehensive coverage rate obtained after code testing is performed based on another code different from the exception code in the target test case is less than a predetermined (or dynamically determined) variation, delete the exception code.

The present specification provides a computer-readable storage medium. The storage medium stores a computer program, and when the computer program is executed by a processor, the previous code testing method is implemented.

The present specification provides an electronic device, including: a memory, a processor, and a computer program that is stored in the memory and can run on the processor. The processor implements the previous code testing method when executing the program.

At least one of the previous technical solutions of the present specification can achieve the following beneficial effects:

In the code testing method provided in the present specification, a member variable corresponding to each operation under test included in each object under test can be determined first, and then variable calling statements corresponding to all member variables are determined, and an operation calling statement sequence is constructed based on a calling order of the methods, so that an initial test case is obtained based on the variable calling statement and the operation calling statement sequence, and finally, a target test case is determined based on an initial test case corresponding to each object under test for testing.

It can be understood from the previous method that, each test case in the present specification corresponds to only one operation under test, and variable calling statements corresponding to all member variables that need to be called are determined in advance during construction of use cases, and a calling order of operations under test in the object under test is taken into consideration. Compared with the existing technologies in which one test case corresponds to multiple objects under test and the test case is constructed by using a construction method in a random statement sequence, the test case in the present solution is not only simple in case statements and is run more stably, but a test effect is significantly improved.

### BRIEF DESCRIPTION OF DRAWINGS

The accompanying drawings illustrated herein are provided to further understand the present specification and form a part of the present specification. The example implementations of the present specification and the descriptions thereof are used to explain the present specification and do not constitute an improper limitation on the present specification. In the drawings:

FIG. 1 is a schematic flowchart illustrating a code testing method according to the present specification;

FIG. 2 is a schematic diagram illustrating a method for generating a target use case according to the present specification;

FIG. 3 is a schematic diagram illustrating a code testing apparatus according to the present specification; and

FIG. 4 is a schematic diagram illustrating an electronic device corresponding to FIG. 1 according to the present specification.

### DESCRIPTION OF IMPLEMENTATIONS

To make the Technical features, technical solutions, and technical advantages of the present specification clearer, the following clearly and completely describes the technical solutions in the present specification with reference to specific implementations of the present specification and corresponding accompanying drawings. Clearly, the described implementations are some rather than all of the implementations of the present specification. All other implementations obtained by a person of ordinary skill in the art based on the implementations of the present specification without creative efforts shall fall within the protection scope of the present specification.

The technical solutions provided in the various implementations of the present specification are described in detail below with reference to the accompanying drawings.

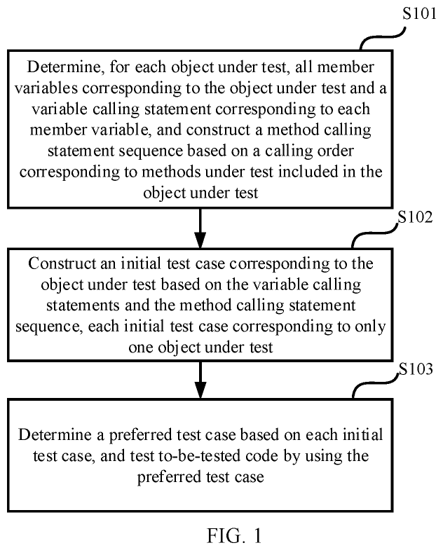

FIG. 1 is a schematic flowchart illustrating a code testing method according to the present specification. The code testing method includes the following steps:
S101: Determine, for each object under test, all member variables corresponding to the object under test and a variable calling statement corresponding to each member variable, and construct a method calling statement sequence or operation calling statement sequence based on a calling order corresponding to methods or operations under test included in the object under test.

In a software development process, software codes need to be tested to ensure the normal running of software. To ensure the smooth implementation of each function of the software in the development process, objects included in different classes of the software code can be independently tested, so that each object under test can be independently tested without the impact from other objects on which the software code depends. As such, if a problem occurs in the software code, a location at which the problem occurs can be easily found to process the problem code, thereby ensuring the smooth running of each class in the software code and an object included in each class, to ensure the smooth running of the software as a whole.

The present specification provides a code testing method. In the method, an object under test is obtained, and the object under test can be a code group for implementing a specific function in code corresponding to a class. In other words, a group of codes for implementing a specific function in the code corresponding to the class can be used as the object under test.

It should be noted that in some implementations of the present specification, one initial test case corresponds to only one object under test, that is, if an object under test has been constructed in an initial test case, no other object under test is constructed.

In addition, in the present specification, the code testing method may be implemented by a specified terminal device such as a notebook computer or a desktop computer, or may be a server. For ease of description, the code testing method provided in the present specification is described merely by using a terminal device as an execution entity.

In a testing process, among some other objects, for example, a bottom-layer service or a bottom-layer module of the object under test, on which the object under test depends or that are called by the object under test, some objects have very complex logical structures. Therefore, if the objects are constructed in the initial test case, not only a large quantity of system resources are wasted, but the constructed objects are not quite stable in an execution process. Once there objects are run normally or an error occurs in a construction process, a test result may be affected.

Therefore, to focus the test on the object under test and eliminate the impact caused to the testing process by the object on which the object under test depends or that is called by the object under test, the terminal device may simulate, by using a method such as mocking, the object on which the object under test depends or that is called by the object under test, to directly obtain returned data of the object. As such, the returned data of the object can be obtained without constructing processing logic of the object, and the object under test is tested by using the returned data, thereby avoiding the impact caused to the test result by the object on which the object under test depends or that is called by the object under test.

For example, the terminal device may analyze the object under test first, to determine all dependent objects on which the object under test depends, and then mock the dependent objects to determine all member variables on which the object under test depends. The member variables may be returned data corresponding to a dependent object on which the current object under test depends or that is called by the current object under test. During the test, the member variables may be input data of the object under test to test the object under test.

Certainly, in practice, among the objects on which the object under test depends or that are called by the object under test, corresponding logical structures of some objects are simple. These objects do not affect the testing process even if these objects are directly constructed in the initial test case. Therefore, the objects with simple logical structures may not be mocked, but are directly constructed in the initial test case to obtain the member variables on which the object under test depends.

After obtaining all the member variables on which the object under test depends, the terminal device may inject, by using a reflective injection algorithm, these member variables into the object under test constructed in the initial test case, to obtain a variable injection statement corresponding to each member variable.

After the injection of all the member variables is completed, the terminal device may assign a value to each member variable based on an initial value and a value range of each member variable, to obtain a variable initialization statement corresponding to each member variable. Then, the terminal device may combine the variable injection statement and the variable initialization statement to obtain a variable calling statement.

For example, the terminal device may first determine variable injection statements corresponding to all the member variables, and then determine variable initialization statements corresponding to all the member variables, and then arrange the variable initialization statements after the variable injection statements to obtain variable calling statements. Certainly, the terminal device may alternatively arrange the variable initialization statement corresponding to each member variable after the variable injection statement corresponding to each member variable to obtain the variable calling statement.

In addition, in the testing process, the terminal device also calls variable parameters corresponding to the member variables and operation parameters corresponding to the methods, actions, operations, or processes under test, referred to as “operations under test” for descriptive purposes. Therefore, the terminal device may also construct the variable parameters corresponding to the member variables and the operation parameters corresponding to the operations under test in the initial test case by using a Mock or New function, to obtain the corresponding parameter calling statements and arrange the parameter calling statements after the variable calling statements.

The terminal device may also perform static analysis on the object under test, to determine the operations under test included in the object under test and a calling order of the operations under test. The operations under test may be one or more functions included in the object under test, and the calling order of the operations under test is the same as an actual execution order of the operations under test during actual execution of the object under test.

For example, in an actual running process of an object under test including an EXECUTE function, an INT function is first executed to assign a value, and then the EXECUTE function is executed. Therefore, in a testing process of the object under test, a calling order of operations under test included in the object under test is an execution order of the two functions, that is, the INT function is executed first, and then the EXECUTE function is executed.

The terminal device may construct a method calling statement or operation calling statement corresponding to each operation under test, construct an operation calling statement sequence based on the calling order of the operations under test, and arrange the operation calling statement sequence after the variable initialization statement.

In the present specification, the terminal device may first determine all member variables corresponding to the object under test and a variable calling statement corresponding to each member variable, and then construct the operation calling statement sequence; or may first construct the operation calling statement sequence, and then determine all member variables corresponding to the object under test and a variable calling statement corresponding to each member variable. Certainly, the two actions may be performed simultaneously. This is not specifically limited in the present specification.
S102: Construct an initial test case corresponding to the object under test based on the variable calling statements and the operation calling statement sequence, each initial test case corresponding to only one object under test.

After determining the operation calling statement sequence and the variable calling statement corresponding to the object under test, the terminal device may construct an initial test case statement based on the variable calling statement, the operation calling statement, and the parameter calling statement.

For example, the terminal device may arrange the parameter calling statement between the variable calling statement and the operation calling statement, to construct a complete initial test case based on such an order: the variable calling statement, the parameter calling statement, and the operation calling statement, and each initial test case corresponds to only one object under test.

It should be noted that test cases generated by using different combinations of operation parameters cover different branches, paths, and selection conditions in the operation under test. Therefore, one operation under test may correspond to multiple initial test cases. It should be noted that although one object under test may correspond to multiple initial test cases, one initial test case corresponds to only one object under test.
S103: Determine a target test case based on each initial test case, and test to-be-tested code by using the target test case.

After determining the initial test cases, the terminal device may reconstruct test cases based on the initial test cases, to obtain candidate test cases.

For example, the terminal device may perform processing such as mutation, e.g., some parameter values are changed randomly to generate new parameters, and crossover, e.g., parameters included in different cases are crossed to generate new parameters, on an operation parameter corresponding to an operation called in the initial test case and a variable parameter corresponding to a called member variable, to obtain a processed operation parameter and a processed member variable parameter. Then, the terminal device may reconstruct the test case based on the processed operation parameter, the processed member variable parameter, and the operation calling statement and the variable calling statement that are included in each initial test case, to obtain the candidate test case.

It should be noted that the candidate test case mentioned in the present specification is a test case generated after reconstruction based on the initial test case; in other words, the candidate test case may be a test case generated after any round of iteration.

The terminal device may thereby complete the first round of iteration of the initial test case and determine whether a predetermined (or dynamically determined) condition is satisfied. The predetermined (or dynamically determined) condition may be that a comprehensive coverage rate corresponding to each candidate test case reaches a predetermined (or dynamically determined) comprehensive coverage rate, or reaches a predetermined (or dynamically determined) number of iterations, and the predetermined (or dynamically determined) coverage rate and the predetermined (or dynamically determined) number of iterations may be set based on actual conditions. This is not specifically limited in the present specification.

In the present specification, the coverage rate may be at least one of a conditional coverage rate, a branch coverage rate, a statement coverage rate, a path coverage rate, and the like that correspond to each candidate test case. This is not specifically limited in the present specification.

In an actual use process, the comprehensive coverage rate may also be represented by, for example, a fitness function. The closer a value of the fitness function is to 0, the larger the comprehensive coverage rate is, and the farther a value of the fitness function is from 0, the smaller the comprehensive coverage rate is. Certainly, the comprehensive coverage rate may be expressed by a reciprocal of a value of the fitness function. A larger reciprocal of the fitness function indicates a larger comprehensive coverage rate, and a smaller reciprocal of the fitness function indicates a smaller comprehensive coverage rate. A function value of the fitness function is greater than or equal to 0.

If the terminal device determines that the candidate test cases obtained after the first round of iteration do not satisfy the predetermined (or dynamically determined) condition, processing such as mutation or crossover is performed on operation parameters corresponding to operations called in the candidate test cases and member variable parameters corresponding to called member variables, to obtain a processed operation parameter and a processed member variable parameter corresponding to each candidate test case.

Then, the terminal device may reconstruct the test cases based on the processed operation parameter and the processed member variable parameter corresponding to each candidate test case obtained after the first round of iteration, and the operation calling statement and the variable calling statement that are included in each candidate test case, until the predetermined (or dynamically determined) condition is satisfied, and determine the target test case from the candidate test cases obtained after the predetermined (or dynamically determined) condition is satisfied.

In addition to the operation under test included in the object under test corresponding to the initial test case, the terminal device may further select some other methods related to the object under test as to-be-inserted operations under test. The to-be-inserted operations under test may be operations related to the object under test that are included in other object under tests, or may be methods included in a class to which other objects under test belong. Certainly, the to-be-inserted operations under test may alternatively or additionally be operations included in a parent class to which the object under test belongs. This is not specifically limited in the present specification.

To avoid repeated construction of the operation calling statement, for each to-be-inserted operation under test, the terminal device may first determine whether a current object under test includes the to-be-inserted operation under test.

If it is determined that the object under test does not include the to-be-inserted operation under test, the terminal device may construct, in the candidate test case, an operation calling statement corresponding to the to-be-inserted operation under test, to insert the operation calling statement corresponding to the to-be-inserted operation under test into an existing operation calling statement sequence in the candidate test case, thereby obtaining a new operation calling statement sequence, and further reconstructing the test case based on the new operation calling statement sequence and the variable calling statement included in the initial test case, to obtain the candidate test case.

Certainly, the terminal device may directly obtain the operation calling statement corresponding to the to-be-inserted operation under test, and determine whether the candidate test case includes the operation calling statement. If the candidate test case does not include the operation calling statement, the terminal device may insert the operation calling statement into the existing operation calling statement sequence in the candidate test case, to reconstruct the test case.

In addition, candidate test cases generated after each round of iteration include some other operation calling statements different from the operation calling statement included in the initial test case. Therefore, the terminal device may randomly delete the operation calling statement, to obtain new candidate test cases while retaining the original operation calling statement in the initial test case.

For each candidate test case, the terminal device may first determine, from the candidate test case, another operation calling statement different from the operation calling statement included in the initial test case, and use the another operation calling statement as a target calling statement, and then delete, based on a predetermined (or dynamically determined) probability, at least part of target calling statements included in the candidate test case, to determine, based on the candidate test case from which the at least part of target calling statements are deleted, a candidate test case obtained after the current round of reconstruction, so as to determine the target test case. The predetermined (or dynamically determined) probability may be determined based on actual conditions. This is not specifically limited in the present specification.

It should be emphasized that because the operation calling statement included in the initial test case, the member variable statement, and the parameter calling statement are statements included in the testing process. If those statements are deleted, the normal running of the test case and the accuracy of a test result may be affected. In some implementations, these statements are maintained in each round of iteration.

In addition, in practice, the terminal device may reconstruct the test case by using at least one of the previous reconstruction operations until the predetermined (or dynamically determined) condition is satisfied, and may determine the target test case based on each candidate test case obtained after the predetermined (or dynamically determined) condition is satisfied.

Further, for each candidate test case obtained after the predetermined (or dynamically determined) condition is satisfied, the terminal device may determine a comprehensive coverage rate corresponding to the candidate test case and a coverage target determined after code testing is performed by using the candidate test case. The coverage target may be a code line, a code branch, an execution path, a selection condition, or the like covered in a process of performing test by using the test case. This is not specifically limited in the present specification.

If the comprehensive coverage rate corresponding to the candidate test case is greater than a predetermined (or dynamically determined) threshold, and the coverage target determined after code testing is performed by using the candidate test case is not completely same as a coverage target determined after code testing is performed by using the determined target test case, it indicates that the candidate use case covers a new test target, and the candidate test case can be used as the target test case.

If the coverage target determined after code testing is performed by using the candidate test case is the same as the coverage target determined after code testing is performed by using the determined target test case, it indicates that the candidate test case does not cover the new test target, and the candidate test case can be deleted. After determining the target test case corresponding to the object under test, the terminal device may traverse each line of code in each target test case, and identify exception code included in each target test case. In an actual testing process, the exception code may be, for example, messy code, error code, or other code independent of the operation under test.

When the exception code is identified, for each exception code, the terminal device may determine a variation of the comprehensive coverage rate obtained after code testing is performed based on another code different from the exception code in the target test case. If the variation is less than a predetermined (or dynamically determined) variation, it indicates that if the exception code is deleted, a coverage rate of the test case is not reduced. As such, even if the exception code is deleted, the test result is not affected. Therefore, the exception code can be deleted, so that code in the target test case is simpler.

However, if the variation is greater than the predetermined (or dynamically determined) variation, it indicates that if the exception code is deleted, the test result is affected, and therefore the exception code is not deleted.

Certainly, in the present specification, the terminal device may first delete the exception code, and then execute the test case to determine the variation of the coverage rate corresponding to the test case. When the variation of the coverage rate corresponding to the test case is greater than the predetermined (or dynamically determined) variation, the terminal device may recover the deleted exception code.

The predetermined (or dynamically determined) variation may be set based on an actual situation. This is not specifically limited in the present specification.

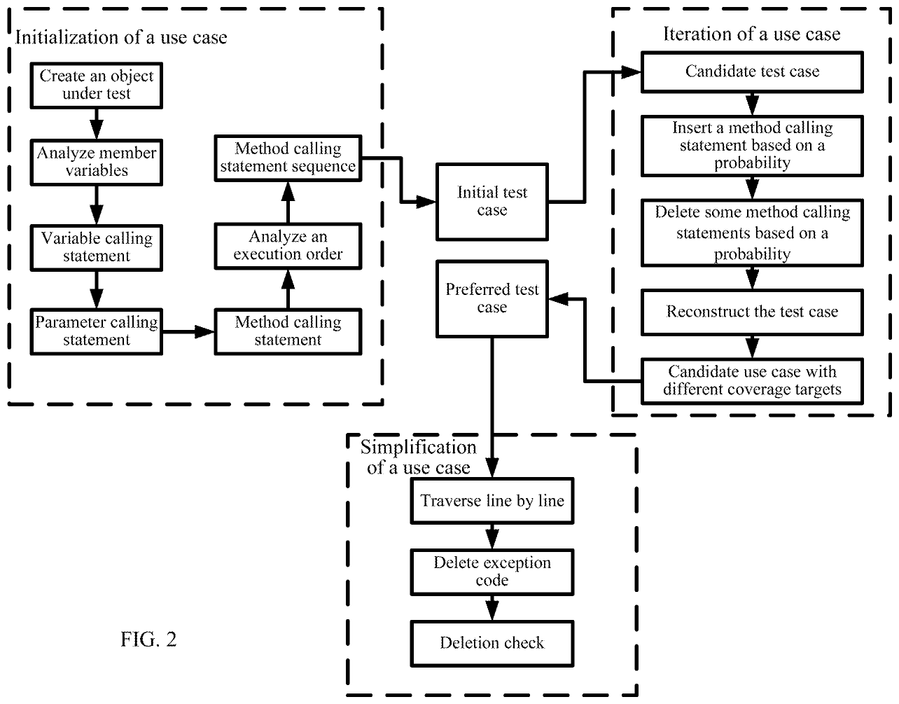

For ease of understanding, the present specification further provides a schematic diagram illustrating a method for generating a target use case, as shown in FIG. 2.

FIG. 2 is a schematic diagram illustrating a method for generating a target use case according to the present specification.

As can be seen from the figure, a process of generating the use case in the present specification is divided into three parts. In the part of initializing the use case, a server may first create an object under test, and then perform member variable analysis to determine all member variables corresponding to the object under test and variable calling statements corresponding to the member variables. Then, the server may determine a parameter calling statement corresponding to a parameter included in the object under test. For each operation under test included in the object under test, the server may analyze an execution order of operations under test included in the object under test, and then determine an operation calling statement sequence. Finally, the server may determine an initial test case based on the variable calling statement, the parameter calling statement, and the operation calling statement sequence.

In the part of iterating the use case, the server may iterate cases based on the initial test case. For a candidate test case generated in each iteration process, the server may randomly insert an operation calling statement not included in the test case into the test case based on a certain probability, and randomly delete, based on a predetermined (or dynamically determined) probability, statements in the candidate test case different from an operation calling statement, a parameter calling statement, and a variable calling statement included in the initial test case, to reconstruct the use case in each iteration process until an iteration target is satisfied, and select candidate test cases with different coverage targets from candidate test cases satisfying the target as target test cases.

In the part of simplifying the use case, the server traverses each line of code in the target test case to identify exception code, and deletes the exception code. When each exception code is deleted, the server further performs a deletion check, that is, determines whether a coverage rate of the test case decreases after the exception code is deleted, and if the coverage rate decreases, the server recovers the deleted exception code.

Then, the terminal device may test the object under test by using the determined target test case.

It should be noted that each initial test case determined by the terminal device corresponds to only one object under test, and therefore, each candidate test case and each target test case also include only one object under test.

It can be understood from the previous method that, each test case in the present specification corresponds to only one operation under test, and variable calling statements corresponding to all member variables that need to be called are determined in advance during construction of use cases, and a calling order of operations under test in the object under test is taken into consideration. Compared with the existing technologies in which one test case corresponds to multiple objects under test and the test case is constructed by using a construction method in a random statement sequence, the test case in the present solution is not only simple in case statements and is run more stably, but a test effect is significantly improved.

In addition, in a process of reconstructing the test cases, the operation calling statement included in the initial test case is not deleted in the present solution, so that the smooth execution of the test is ensured. In addition, in the present solution, candidate test cases with the same coverage target are not used as target test cases, so that a comprehensive coverage rate of the test case is further improved while the number of test cases is effectively reduced.

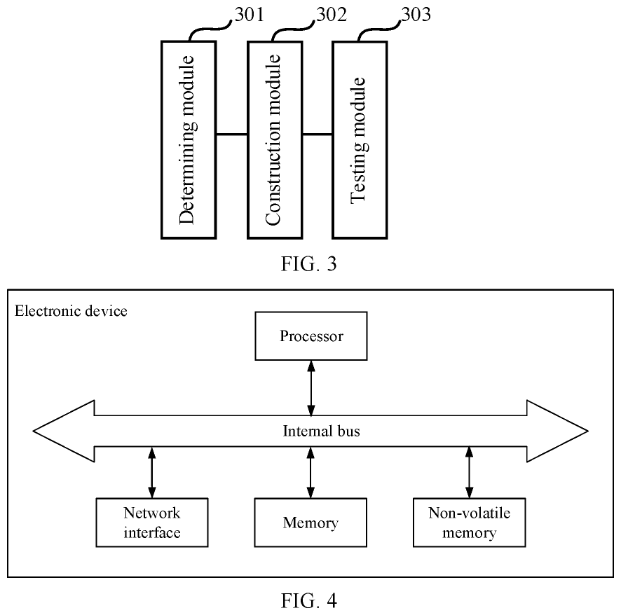

One or more code testing methods in the present specification are provided above. Based on the same idea, the present specification further provides a corresponding code testing apparatus, as shown in FIG. 3.

FIG. 3 is a schematic diagram illustrating a code testing apparatus according to the present specification. The code testing apparatus includes: a determining module 301, configured to: determine, for each object under test, all member variables corresponding to the object under test and a variable calling statement corresponding to each member variable, and construct an operation calling statement sequence based on a calling order corresponding to operations under test included in the object under test; a construction module 302, configured to construct an initial test case corresponding to the object under test based on the variable calling statements and the operation calling statement sequence, each initial test case corresponding to only one object under test; and a testing module 303, configured to determine a target test case based on each initial test case, and test to-be-tested code by using the target test case.

In some implementations, the determining module 301 is configured to: for each object under test, determine all the member variables corresponding to the object under test and a variable injection statement corresponding to each member variable; determine a variable initialization statement corresponding to each member variable based on an initial value and a value range corresponding to the member variable; and combine the variable initialization statement and the variable injection statement to construct the variable calling statement corresponding to each member variable.

In some implementations, the testing module 303 is configured to: reconstruct a test case based on each initial test case to obtain a candidate test case; and determine the target test case based on each candidate test case.

In some implementations, the testing module 303 is configured to: process an operation parameter corresponding to an operation called in each initial test case and a member variable parameter corresponding to a called member variable to obtain a processed operation parameter and a processed member variable parameter; and reconstruct the test case based on the processed operation parameter, the processed member variable parameter, and an operation calling statement and a variable calling statement that are included in each initial test case, to obtain the candidate test case.

In some implementations, the testing module 303 is configured to: for each initial test case, if an object under test corresponding to the initial test case does not include a determined to-be-inserted operation under test, reconstruct the test case based on an operation calling statement corresponding to the to-be-inserted operation under test and based on an operation calling statement and a variable calling statement that are included in the initial test case, to obtain the candidate test case.

In some implementations, the testing module 303 is configured to: determine, for each candidate test case, another operation calling statement different from an operation calling statement included in the initial test case from the candidate test case as a target calling statement; and delete, based on a predetermined (or dynamically determined) probability, at least part of target calling statements included in the candidate test case, to determine the target test cases based on the candidate test case from which the at least part of target calling statements are deleted.

In some implementations, the testing module 303 is configured to: for each candidate test case, if a comprehensive coverage rate corresponding to the candidate test case is greater than a predetermined (or dynamically determined) threshold, and a coverage target determined after code testing is performed by using the candidate test case is not completely same as a coverage target determined after code testing is performed by using the determined target test case, use the candidate test case as the target test case.

In some implementations, the test module 303 is further configured to: traverse each line of code in the target test case to identify exception code included in the target test case; and if it is determined that a variation of a comprehensive coverage rate obtained after code testing is performed based on another code different from the exception code in the target test case is less than a predetermined (or dynamically determined) variation, delete the exception code.

The present specification further provides a computer-readable storage medium. The storage medium stores a computer program, and the computer program may be configured to perform the code testing method provided in FIG. 1.

The present specification further provides a schematic diagram illustrating a structure of an electronic device corresponding to FIG. 1, as shown in FIG. 4. As shown in FIG. 4, at a hardware level, the electronic device includes a processor, an internal bus, a network interface, a memory, and a non-volatile memory, and may certainly include hardware required by other services. The processor reads a corresponding computer program from the non-volatile memory into the memory and then runs the computer program to implement the code testing method described in FIG. 1. Certainly, in addition to a software implementation, the present specification does not exclude other implementations, such as a logic device or a combination of software and hardware. In other words, an execution entity of the following processing flow is not limited to each logic unit, but can also be hardware or logic devices.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (e.g., a field programmable gate array (FPGA)) is such an integrated circuit, and a logical function of the PLD is determined by a user through device programming. A digital system is “integrated” on a PLD by a designer without requiring a chip manufacturer to design and manufacture a dedicated integrated circuit chip. In addition, at present, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. Those skilled in the art should also be clear that a hardware circuit for implementing the logic method procedure can be easily obtained by performing logic programming the method procedure by using a few hardware description languages and programming the method procedure into an integrated circuit.

A controller may be implemented in any suitable way, for example, the controller may use a form such as a micro-processor, a processor, or a computer-readable medium, a logic gate, a switch, an application specific integrated circuit (ASIC), a programmable logic controller, or an embedded micro-controller storing computer-readable program code (such as software or firmware) that can be executed by the (micro)-processor. Examples of the controller include but are not limited to the following micro-controllers: ARC 625D, Atmel AT91SAM, Microchip PIC18F26K20, and Silicone Labs C8051F320. The memory controller may also be implemented as a part of control logic of the memory. A person skilled in the art also knows that, in addition to implementing the controller in a pure computer-readable program code way, logic programming can absolutely be performed on method steps to enable the controller to implement the same function in a form of a logic gate, a switch, an application specific integrated circuit, a programmable logic controller, or an embedded micro-controller. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

Systems, apparatuses, modules, or units that are set forth in the previous implementations may be embodied by a computer chip or an entity or by a product with a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or any combination of these devices.

For ease of description, the previous apparatus is described by dividing functions into various units. Certainly, when the present specification is implemented, a function of each unit can be implemented in one or more pieces of software and/or hardware.

A person skilled in the art should understand that the implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on the implementations of the present specification. It should be understood that computer program instructions can be used to implement each process and/or each block in the flowcharts and/or the block diagrams and a combination of processes and/or blocks in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate a device for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so that a series of operations and steps are performed on the computer or the another programmable device, thereby generating computer-implemented processing. Therefore, the instructions executed on the computer or the other programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes permanent and non-permanent, removable and non-removable media, and can store information by using any method or technology. The information can be a computer-readable instruction, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or their any other variants are intended to cover a non-exclusive inclusion, so a process, a method, a product, or a device that includes a list of elements not only includes those elements but also includes other elements that are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions executed by a computer, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communication network. In the distributed computing environment, the program module can be located in both local and remote computer storage media including storage devices.

The implementations in the present specification are described in a progressive way. For same or similar parts of the implementations, mutual references can be made to the implementations. Each implementation focuses on a difference from other implementations. Particularly, a system implementation is similar to a method implementation, and therefore is described briefly. For related parts, references can be made to related descriptions in the method implementation.

The previous descriptions are merely implementations of the present specification and are not intended for limiting the present specification. For a person skilled in the art, the present specification can be subject to various modifications and variations. Any modifications, equivalent replacements, and improvements made within the spirit and principle of the present specification shall fall within the scope of the claims in the present specification.

What is claimed is:

1. A code testing method, comprising:
determining, for an object under test of a plurality of objects under test, member variables corresponding to the object under test and a variable calling statement corresponding to each member variable of the member variables;
constructing an operation calling statement sequence based on a calling order corresponding to operations under test included in the object under test;
constructing an initial test case corresponding to the object under test based on the variable calling statements and the operation calling statement sequence;
determining a target test case based on a plurality of initial test cases corresponding to the plurality of objects under test; and
testing to-be-tested code by using the target test case.

2. The method according to claim 1, wherein the determining, for the object under test, all the member variables corresponding to the object under test and the variable calling statements corresponding to the member variables includes:
determining all the member variables corresponding to the object under test and a variable injection statement corresponding to each member variable;
determining a variable initialization statement corresponding to each member variable based on an initial value and a value range corresponding to the member variable; and
combining the variable initialization statement and the variable injection statement to construct the variable calling statement corresponding to each member variable.

3. The method according to claim 1, wherein the determining the target test case based on the plurality of initial test cases includes:
reconstructing a test case based on each initial test case of the plurality of test cases to obtain a candidate test case; and
determining the target test case based on each candidate test case.

4. The method according to claim 3, wherein the reconstructing the test case based on each initial test case to obtain the candidate test case includes:
processing an operation parameter corresponding to an operation called in each initial test case and a member variable parameter corresponding to a called member variable to obtain a processed operation parameter and a processed member variable parameter; and
reconstructing the test case based on the processed operation parameter, the processed member variable parameter, and an operation calling statement and a variable calling statement that are included in each initial test case, to obtain the candidate test case.

5. The method according to claim 3, wherein the reconstructing the test case based on each initial test case to obtain the candidate test case includes:
for each initial test case, if an object under test corresponding to the initial test case does not include a determined to-be-inserted operation under test, reconstructing the test case based on an operation calling statement corresponding to the determined to-be-inserted operation under test and based on an operation calling statement and a variable calling statement that are included in the initial test case, to obtain the candidate test case.

6. The method according to claim 3, wherein the determining the target test case based on each candidate test case includes:
determining, for each candidate test case, another operation calling statement from the candidate test case different from an operation calling statement included in the corresponding initial test case as a target calling statement; and
deleting, based on a determined probability, at least part of target calling statements included in the candidate test case, to determine the target test cases based on the candidate test case from which the at least part of target calling statements are deleted.

7. The method according to claim 3, wherein the determining the target test case based on each candidate test case includes:
for each candidate test case, if a comprehensive coverage rate corresponding to the candidate test case is greater than a threshold, and a coverage target determined after code testing is performed by using the candidate test case is not completely same as a coverage target determined after code testing is performed by using the determined target test case, using the candidate test case as the target test case.

8. The method according to claim 1, further comprising:
traversing each line of code in the target test case to identify exception code included in the target test case; and
if it is determined that a variation of a comprehensive coverage rate obtained after code testing is performed based on another code different from the exception code in the target test case is less than a determined variation, deleting the exception code.

9. A computing system comprising one or processors and one or more memory devices, the one or more memory devices having computer executable instructions stored thereon, which when executed by the one or more processors, enable the one or more processors to implement acts including:
determining, for an object under test of a plurality of objects under test, member variables corresponding to the object under test and a variable calling statement corresponding to each member variable of the member variables;
constructing an operation calling statement sequence based on a calling order corresponding to operations under test included in the object under test;
constructing an initial test case corresponding to the object under test based on the variable calling statements and the operation calling statement sequence;
determining a target test case based on a plurality of initial test cases corresponding to the plurality of objects under test; and
testing to-be-tested code by using the target test case.

10. The computing system according to claim 9, wherein the determining, for the object under test, all the member variables corresponding to the object under test and the variable calling statements corresponding to the member variables includes:
determining all the member variables corresponding to the object under test and a variable injection statement corresponding to each member variable;
determining a variable initialization statement corresponding to each member variable based on an initial value and a value range corresponding to the member variable; and
combining the variable initialization statement and the variable injection statement to construct the variable calling statement corresponding to each member variable.

11. The computing system according to claim 9, wherein the determining the target test case based on the plurality of initial test cases includes:
reconstructing a test case based on each initial test case of the plurality of test cases to obtain a candidate test case; and
determining the target test case based on each candidate test case.

12. The computing system according to claim 11, wherein the reconstructing the test case based on each initial test case to obtain the candidate test case includes:
processing an operation parameter corresponding to an operation called in each initial test case and a member variable parameter corresponding to a called member variable to obtain a processed operation parameter and a processed member variable parameter; and
reconstructing the test case based on the processed operation parameter, the processed member variable parameter, and an operation calling statement and a variable calling statement that are included in each initial test case, to obtain the candidate test case.

13. The computing system according to claim 11, wherein the reconstructing the test case based on each initial test case to obtain the candidate test case includes:
for each initial test case, if an object under test corresponding to the initial test case does not include a determined to-be-inserted operation under test, reconstructing the test case based on an operation calling statement corresponding to the determined to-be-inserted operation under test and based on an operation calling statement and a variable calling statement that are included in the initial test case, to obtain the candidate test case.

14. The computing system according to claim 11, wherein the determining the target test case based on each candidate test case includes:
determining, for each candidate test case, another operation calling statement from the candidate test case different from an operation calling statement included in the corresponding initial test case as a target calling statement; and
deleting, based on a determined probability, at least part of target calling statements included in the candidate test case, to determine the target test cases based on the candidate test case from which the at least part of target calling statements are deleted.

15. The computing system according to claim 11, wherein the determining the target test case based on each candidate test case includes:
for each candidate test case, if a comprehensive coverage rate corresponding to the candidate test case is greater than a threshold, and a coverage target determined after code testing is performed by using the candidate test case is not completely same as a coverage target determined after code testing is performed by using the determined target test case, using the candidate test case as the target test case.

16. The computing system according to claim 9, wherein the acts further include:
traversing each line of code in the target test case to identify exception code included in the target test case; and
if it is determined that a variation of a comprehensive coverage rate obtained after code testing is performed based on another code different from the exception code in the target test case is less than a determined variation, deleting the exception code.

17. A non-transitory storage medium having computer executable instruction stored thereon, the executable instructions when executed by a processor enabling the processor to implement acts comprising:
determining, for an object under test of a plurality of objects under test, member variables corresponding to the object under test and a variable calling statement corresponding to each member variable of the member variables;
constructing an operation calling statement sequence based on a calling order corresponding to operations under test included in the object under test;
constructing an initial test case corresponding to the object under test based on the variable calling statements and the operation calling statement sequence;
determining a target test case based on a plurality of initial test cases corresponding to the plurality of objects under test; and
testing to-be-tested code by using the target test case.

18. The non-transitory storage medium according to claim 17, wherein the determining, for the object under test, all the member variables corresponding to the object under test and the variable calling statements corresponding to the member variables includes:
determining all the member variables corresponding to the object under test and a variable injection statement corresponding to each member variable;
determining a variable initialization statement corresponding to each member variable based on an initial value and a value range corresponding to the member variable; and
combining the variable initialization statement and the variable injection statement to construct the variable calling statement corresponding to each member variable.

19. The non-transitory storage medium according to claim 17, wherein the determining the target test case based on the plurality of initial test cases includes:
reconstructing a test case based on each initial test case of the plurality of test cases to obtain a candidate test case; and
determining the target test case based on each candidate test case.

20. The non-transitory storage medium according to claim 19, wherein the reconstructing the test case based on each initial test case to obtain the candidate test case includes:
processing an operation parameter corresponding to an operation called in each initial test case and a member variable parameter corresponding to a called member variable to obtain a processed operation parameter and a processed member variable parameter; and
reconstructing the test case based on the processed operation parameter, the processed member variable parameter, and an operation calling statement and a variable calling statement that are included in each initial test case, to obtain the candidate test case.
